(19) United States
(12) Patent Application Publication
(10) Pub. No.: US 2003/0076315 A1
(43) Pub. Date: Apr. 24, 2003

(54) Flat panel display and method of adjusting a display screen thereof

(76) Inventor: Ming-Teh Yu, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/163,743

(22) Filed: Jun. 5, 2002

(30) Foreign Application Priority Data
Oct. 24, 2001 (TW) 90126332

(51) Int. Cl. G09G 5/00

(52) U.S. Cl. 345/211

(57) ABSTRACT

A flat panel display (10) and a method of adjusting display characteristics of a display screen (300) of the flat panel display is the subject of the present invention. The flat panel display includes a power switch button (101) and several function buttons (102), all of which are positioned and functions at a side of the display screen. The flat panel display provides “On Screen Display” (OSD) software. When the OSD software is driven, indicating symbols (302) indicating the positions of the function buttons are displayed on the display screen along with a main menu (301), so that a user can adjust the display characteristics of the display screen easily. The method mainly includes: driving OSD software to provide the main menu and indicating symbols; deciding whether to adjust display characteristics of the display screen; selecting a display function for adjustment; confirming the selection; adjusting the display function; confirming the adjustment; and closing the main menu and indicating symbols.

### BACKGROUND OF THE INVENTION

1. Field of the Invention

The present invention relates to flat panel displays, and particularly to a flat panel display with function buttons positioned at a side thereof and a method of adjusting a display screen of the flat panel display.

2. Description of Prior Art

Conventional cathode ray tube (CRT) displays have the following drawbacks: large volume, high operating voltage, high electricity consumption, and high radiation. Hence modern display units being developed are characterized by small volume, low voltage, low electricity consumption, and low radiation. Flat panel displays are among the most popular of such modem display units. The variety of flat panel displays now existing include liquid crystal displays (LCDs), electronic luminescent displays, light-emitting diode displays, plasma displays and vacuum fluorescent displays. In recent years, LCDs have become increasingly widespread in various fields. For example, liquid crystal front projectors (front-projection type) and liquid crystal rear projectors (rear-projection type) are used for public presentations. Such projectors can clearly project enlarged images of personal computer screens when such screens are LCDs (direct-view type). Such LCDs have become well established as the most popular kind of display units apart from CRT displays.

A typical display unit has an array of function buttons for adjusting various display characteristics of a display screen of the display unit. Such display characteristics include size, position, brightness, contrast, and time clock. The buttons are controlled by an integrated circuit (IC). The buttons of a conventional flat panel display are positioned at a front bezel of a frame of the flat panel display, below a display screen of the flat panel display. Each button is accompanied by a distinguishing symbol that indicates the function of the button. In a conventional display unit, each display characteristic is controlled by a separate button having a corresponding symbol. When numerous display characteristics are adjustable, manufacturing of the display unit is complicated by the numerous buttons and the size of the display unit is unduly large.

FIG. 5 shows one kind of conventional display unit. A power button 21 and a plurality of adjusting buttons 22 are positioned on a front bezel 20 of a frame of the display unit, below a display screen of the display unit. Symbols (not labeled) indicating the functions of the adjusting buttons 22 are printed above the adjusting buttons 22. When one of the adjusting buttons 22 is pressed, a main menu of “on screen display” (OSD) software appears on the display screen automatically. Guided by the main menu, a user can press the adjusting buttons 22 to adjust various display characteristics of the display screen. Since the adjusting buttons 22 and the symbols are positioned on the front bezel 20 of the frame, the size of the display unit is unduly large.

Thus, it is desired to provide a flat panel display which overcomes the above-mentioned problems.

### SUMMARY OF THE INVENTION

Accordingly, an object of the present invention is to provide a flat panel display which is more aesthetically pleasing and which has a display screen which can be easily adjusted.

A another object of the present invention is to provide a method of adjusting display characteristics of a display screen of a flat panel display that fulfils the aforementioned objects.

To achieve the above objects, the present invention provides a flat panel display and a method of adjusting display characteristics of a display screen of the flat panel display. The flat panel display comprises a power switch button and a plurality of function buttons. The power switch button and the function buttons are positioned at a side of the display screen. The flat panel display provides “On Screen Display” (OSD) software. When the OSD software is driven, symbols indicating the positions and functions of the function buttons are displayed on the display screen of the flat panel display along with a main menu of display characteristics, so that a user can adjust the display characteristics of the display screen easily.

A method of the present invention for adjusting display characteristics of a display screen of a flat panel display mainly comprises the following steps:

driving OSD software to provide a main menu and indicating symbols;

deciding whether to adjust display characteristics of the display screen;

selecting a display function for adjustment;

confirming the selected display function;

adjusting the selected display function;

confirming the adjustment made; and

closing the main menu and indicating symbols.

Other objects, advantages and novel features of the present invention will be drawn from the following detailed description of a preferred embodiment of the present invention with attached drawings, in which:

### BRIEF DESCRIPTION OF THE DRAWINGS

FIG. 1 is a perspective view of a flat panel display in accordance with a preferred embodiment of the present invention;

FIG. 2 is a flow chart of a method of adjusting display characteristics of a display screen of a flat panel display in accordance with a preferred embodiment of the present invention;

FIG. 3 is similar to FIG. 1, but also shows a main menu and indicating symbols displayed on a display screen of the flat panel display,

FIG. 4 is similar to FIG. 3, but shows a brightness adjustment bar for adjusting brightness of the display screen; and

FIG. 5 is a perspective view of a conventional flat panel display.

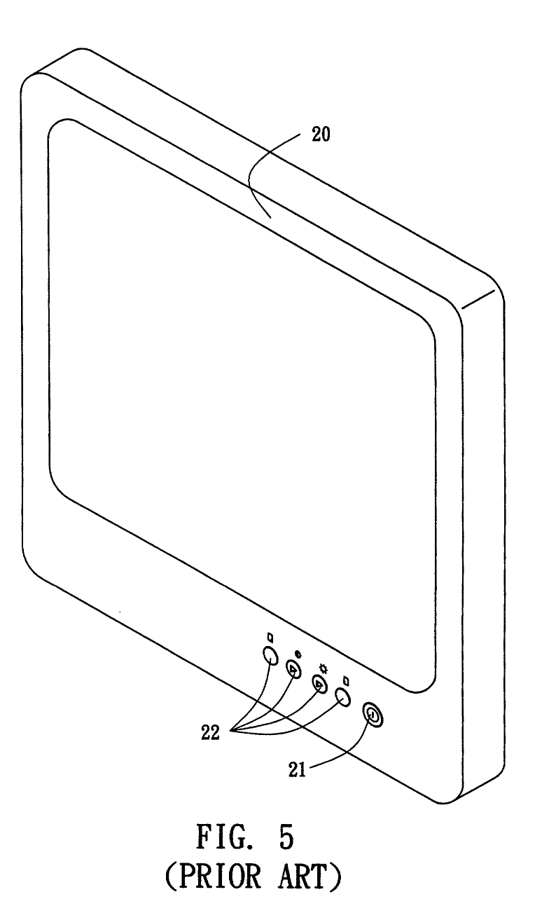

### DETAILED DESCRIPTION OF PREFERRED EMBODIMENT

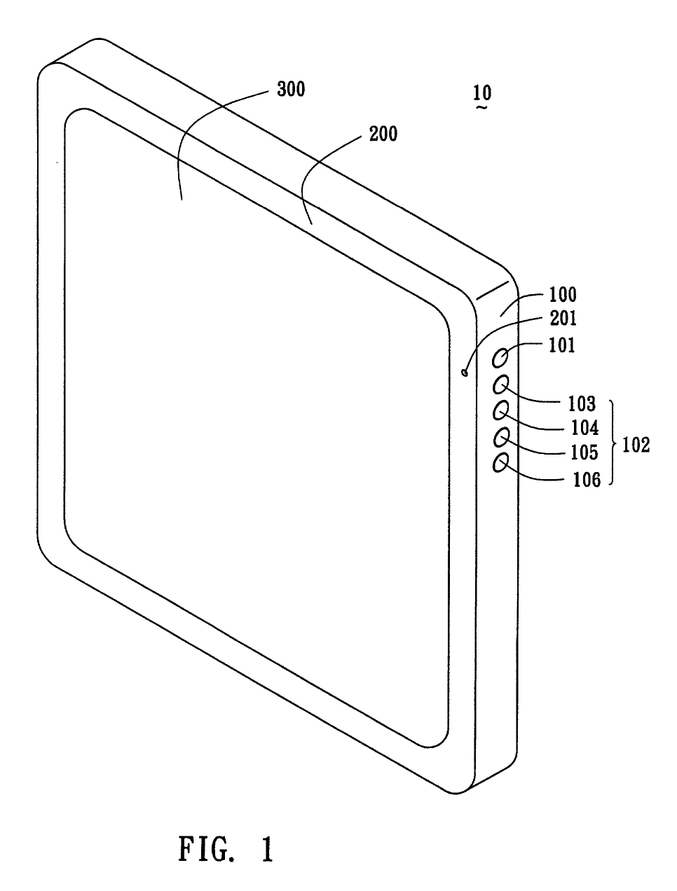

Referring to FIG. 1, a flat panel display 10 in accordance with a preferred embodiment of the present invention comprises a frame (not labeled), a display screen 300, a power switch button 101, an indicating light 201 and a set of function buttons 102. The frame comprises a side frame surface 100, and a front frame surface 200 around a periphery of the display screen 300. The power switch button 101 and the function buttons 102 are positioned in the frame on the side frame surface 100. The function buttons 102 are positioned in vertical alignment below the power switch button 101. The function buttons 102 comprise, in order from top to bottom, a confirmation button 103, adjusting buttons 104, 105, and a return button 106. The indicating light 201 is positioned in the frame on the front frame surface 200, at a same level as the power switch button 101. The indicating light 201 is for indicating an on or off status of the power switch button 101.

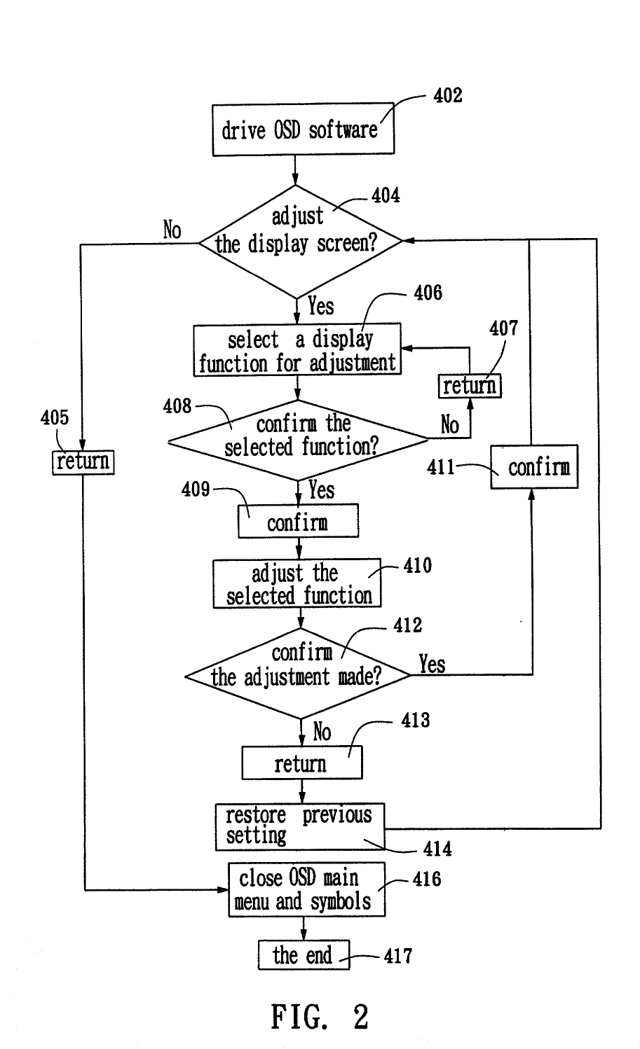

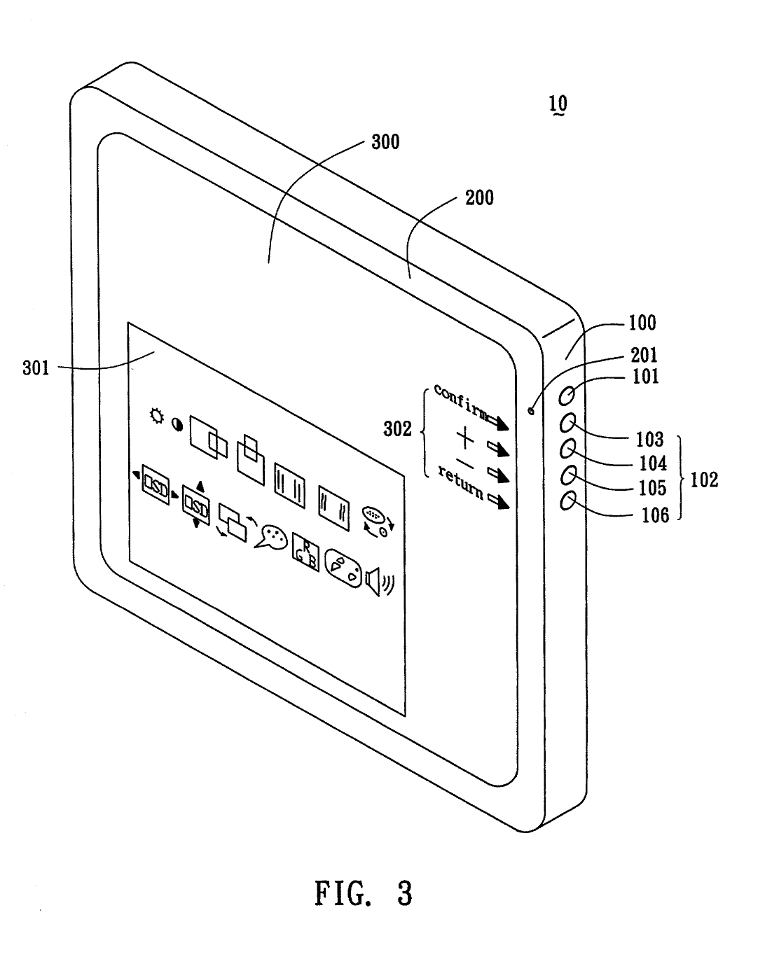

FIG. 2 is a flow chart of a method in accordance with a preferred embodiment of the present invention for adjusting display characteristics of the display screen 300 of the flat panel display 10. Assuming the power switch button 101 to be on, in step 402 of FIG. 2, a user of the flat panel display 10 presses any one of the function buttons 102, which automatically drives the “On Screen Display” (OSD) software to display a main menu 301 and indicating symbols 302 on the display screen 300 (see FIG. 3). The indicating symbols 302 are near to and respectively point to the function buttons 102. In step 404, the user decides whether to adjust display characteristics of the display screen 300. If the user decides not to adjust display characteristics, then in step 405 the user presses the return button 106. This closes the main menu 301 and indicating symbols 302 (step 416), whereupon the procedure for adjustment is ended (step 417).

If the user decides to adjust display characteristics, then in step 406 the user presses the adjusting buttons 104 or 105 to select a display function from the main menu 301 for adjustment. In step 408, the user decides whether to confirm the function selected for adjustment. If the user wants to confirm the function selected for adjustment, then in step 409 the user presses the confirmation button 103. If the user does not want to confirm the function selected for adjustment, then in step 407 the user presses the return button 106, which takes the user back to step 406. After step 409, in step 410 the user adjusts the selected function by pressing the adjusting buttons 104, 105. In step 412, the user decides whether to confirm the adjustment made. If the user wants to confirm the adjustment made, then in step 411 the user presses the confirmation button 103, which takes the user back to step 404. If the user does not want to confirm the adjustment made, then in step 413 the user presses the return button 106. This restores the previous setting of the function selected for adjustment (step 414), and takes the user back to step 404.

In a typical application of the above-described method, the user presses one of the function buttons 102, whereupon the main menu 301 and indicating symbols 302 of the OSD software appear on the display screen 300 (see FIG. 3). The indicating symbols 302 are near to and respectively point to the function buttons 102. Guided by the main menu 301 and the indicating symbols 302, the user can press the adjusting buttons 104, 105 to select the display function item that is desired to be adjusted. When the desired display function item is selected, the user can press the confirmation button 103 to confirm the selection.

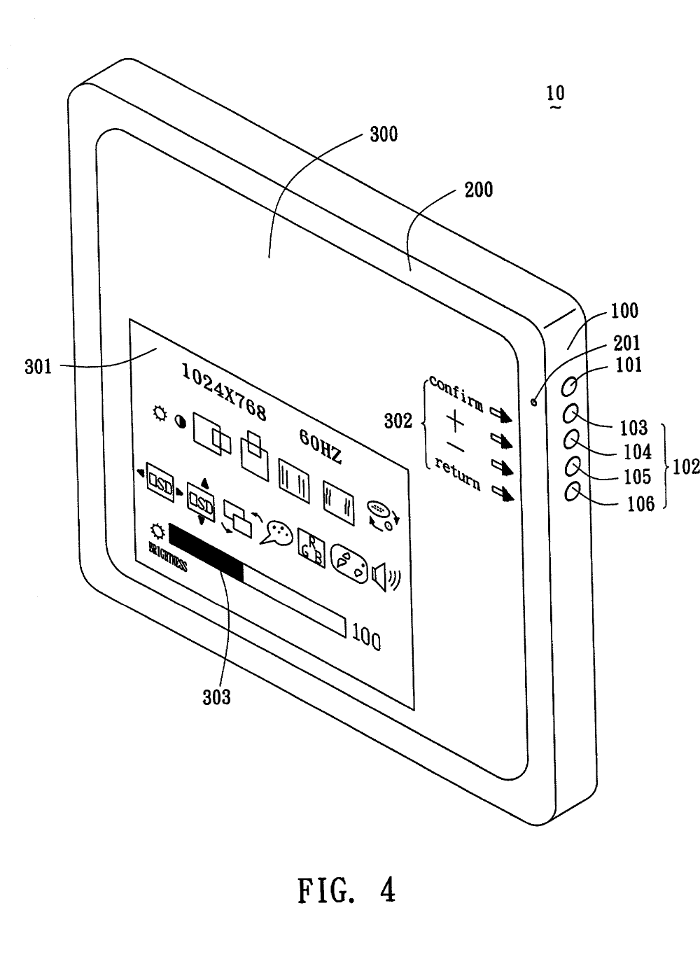

FIG. 4 shows the flat panel display 10 when the user has selected brightness of the display screen 300 for adjustment. An adjustment bar 303 appears in the main menu 301. A length of the darkened position of the adjustment bar 303 indicates a degree of brightness. Guided by the indicating symbols 302, the user can press the buttons 104, 105 to adjust brightness. When the adjusting button 104 is pressed, the darkened position of the adjustment bar 303 extends rightward, and the brightness is progressively increased. When the adjusting button 105 is pressed, the darkened position of the adjustment bar 303 recedes leftward, and the brightness is progressively decreased. When the user is satisfied with the adjustment made, the user can press the confirmation button 103 to confirm the adjustment made.

To adjust the display characteristics of the flat panel display 10, the user can also press a number of predetermined keys on an accompanying keyboard to drive selection of display function from the main menu 301 and to drive the indicating symbols 302 of the OSD software, instead of pressing the function buttons 102.

Since the present invention places the indicating symbols 302 Conveniently opposite to and pointing to the positions of the function buttons 102, the user can conveniently sue the function buttons 102 to adjust the display characteristics of the display screen 300.

In the flat panel display 10 of the present invention, the function buttons 102 are positioned on the side frame surface 100 and are labeled by the indicating symbols 302. This enables a size of the flat panel display 10 to be reduced. In addition, the relatively uncluttered display function items shown on the main menu 301 and the indicating symbols 302 on the display screen 300 can be displayed large and clearly and can be made more aesthetically pleasing. Furthermore, the indicating symbols permanently displayed on the bezel of a conventional display unit are not required to on the flat panel display 10 of the present invention. That is, additional molding and/or printing of indicating symbols on the flat panel display 10 are not required. Therefore, manufacturing is simplified and costs are reduced.

Although the present invention has been described with reference to specific embodiments, it should be noted that the described embodiments are not necessarily exclusive and that various changes and modifications may be made to the described embodiments without departing from the scope of the present invention as defined by the appended claims.

What is claimed is:

1. A display unit comprising:
a screen;
a frame substantially surrounding the screen and having a side; and
a plurality of buttons for adjusting display characteristics of the screen, the buttons being arranged on the side of the frame;
wherein when a menu and symbols of “on screen display” software appear on the screen, the symbols respectively indicate positions and functions of the buttons.

2. The display unit in accordance with claim 1, further comprising a power switch arranged on the frame.

3. The display unit in accordance with claim 2, further comprising an indicating light arranged on the frame.

4. The display unit in accordance with claim 3, wherein the power switch and the indicating light are substantially at a same level.

5. The display unit in accordance with claim 1, wherein the symbols point to respective buttons.

6. The display unit in accordance with claim 1, wherein the symbols are located near respective buttons.

7. A method of adjusting a display characteristics of a display unit, the method comprising the steps of:
providing a display unit comprising:
a screen;
a frame substantially surrounding the screen and having a side; and
a plurality of buttons arranged on the side of the frame for adjusting display characteristics of the screen;
displaying a main menu and symbols on the screen using of “on screen display” software; and
adjusting a display characteristic of the screen by operating at least one of the buttons indicated by the symbols.

8. The method of adjusting a display characteristic of a display unit in accordance with claim 7, wherein the display unit further comprises a switch arranged on the frame.

9. The method of adjusting a display characteristic of a display unit in accordance with claim 8, wherein the display unit further comprises an indicating light arranged on the frame.

10. The method of adjusting a display characteristic of a display unit in accordance with claim 9, wherein the indicating light and the switch are substantially at a same level.

11. The method of adjusting a display characteristic of a display unit in accordance with claim 7, wherein the symbols point to respective buttons.

12. The method of adjusting a display characteristic of a display unit in accordance with claim 11, wherein the symbols are located near respective buttons.

13. A display unit assembly comprising:
a screen;
a frame substantially surrounding the screen;
a side face extending from one edge of the frame and being perpendicular to a plane defined by the frame;
a plurality of adjusting buttons located on the side face and adapted to be touched in a lateral direction perpendicular to said side face; and
function symbols generated by a software displayed on the screen close to said side face and respectively indicating positions of the corresponding adjusting buttons aside.

14. The assembly as claimed in claim 13, wherein none or fewer buttons in comparison with said adjusting buttons, are disposed on the frame parallel to said plane.
